(19) United States
(12) Patent Application Publication
(10) Pub. No.: US 2017/0103194 A1
(43) Pub. Date: Apr. 13, 2017

(54) SYSTEMS AND METHODS FOR ACTIVE AUTHENTICATION

(71) Applicant: PCMS Holdings, Inc., Wilmington, DE (US)

(72) Inventor: Harry Wechsler, Fairfax, VA (US)

(73) Assignee: PCMS Holdings, Inc., Wilmington, DE (US)

(21) Appl. No.: 15/314,930

(22) PCT Filed: May 30, 2015
(86) PCT No.: PCT/US15/33430

§ 371 Date: Nov. 29, 2016

Related U.S. Application Data
(60) Provisional application No. 62/004,976, filed on May 30, 2014.

(51) Int. Cl. G06F 21/31; G06F 21/32

(52) U.S. Cl. CPC G06F 21/316; G06F 21/32; G06F 2221/2139

(57) ABSTRACT

Systems, methods, and/or techniques for performing active authentication on a device during a session with a user may be provided to detect an imposter. To perform active authentication, meta-recognition may be performed. For example, an ensemble method to facilitate detection of the imposter. The ensemble method may user discrimination using random boost and/or intrusion or change detection using transduction. Scores and/or results may be received from the ensemble method. A determination may be made, based on the scores and/or results, whether to continue to enable access to the device, whether to invoke collaborative filtering and/or challenge-responses for additional information, and/or whether to lock the device. Based on the determination, user profile adaptation on a user profile used in the ensemble method and/or the determination and/or retrain the ensemble method, collaborative filtering and/or challenge-responses, and/or a lock procedure may be performed.

### CROSS-REFERENCE TO RELATED APPLICATIONS

This application claims the benefit of the U.S. Provisional Application No. 62/004,976, filed May 30, 2014, which is hereby incorporated by reference herein.

### BACKGROUND

Today, devices such as mobile devices may use passcodes, passwords, and/or the like to authenticate whether a user may be authorized to access a device and/or content on the device. In particular, a user may input a passcode or password before the user may be able to use a device such as a mobile phone or tablet. For example, after a period of non-use a device may be locked. To unlock and use the device again, the user may be prompted to input a passcode or password. If the pass code or password may match the stored passcode or password, the device may be unlocked such that the user may access and/or use the device without limitation. As such, the passcodes and/or passwords may help prevent unauthorized use of a device that may be locked. Unfortunately, many users do not protect their devices with such a passcode and/or password. Additionally, once the device may be unlocked, many users may forget to relock the device and, as such, the device may remain unlocked until, for example, the expiration of a period of non-use associated with the device. In situations where a passcode and/or password may not be used and/or after a device may be unlocked and before the expiration of a period of non-use, currently devices may be susceptible to be accessed by unauthorized users and, as such, content on the device may be compromised and/or harmful or unauthorized actions performed may be performed using the device.

### SUMMARY

Systems, methods, and/or techniques for authenticating a user of a device may be provided. In examples, the systems, methods, and/or techniques may perform active authentication on a device during a session with a user to detect an imposter. To perform active authentication, meta-recognition may be performed. For example, an ensemble method to facilitate detection of an imposter may be performed and/or accessed. The ensemble method may seek for user authentication and/or discrimination using random boost and/or intrusion or change detection using transduction. Scores and/or results may be received from the ensemble method. A determination may be made, based on the scores and/or results, whether to continue to enable access to the device, whether to invoke collaborative filtering and/or challenge-responses for additional information, and/or whether to lock the device. Based on the determination, user profile adaptation on a user profile used in the ensemble method and/or the determination and/or retrain the ensemble method may be performed when, based on the determination, access to the device should be continued. Collaborative filtering and/or challenge-responses may be performed when, based on the determination, collaborative filtering and/or challenge-responses should be invoked for additional information. A lock procedure when, based on the determination, the device should be locked may be performed.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to the examples or limitations that solve one or more disadvantages noted in any part of this disclosure.

### BRIEF DESCRIPTION OF THE DRAWINGS

A more detailed understanding of the embodiments disclosed herein may be had from the following description, given by way of example in conjunction with the accompanying drawings.

FIG. 1 illustrates an example method for performing meta-recognition (e.g., for active authentication).

FIG. 2 illustrates an example method for performing user discrimination, for example, using random boost.

FIG. 3 illustrates an example method for performing intrusion (“change”) detection using, for example, transduction as described herein.

FIG. 4 illustrates an example method for performing user profile adaptation as described herein.

FIG. 5 illustrates an example method for performing collaborative filtering and/or providing challenges, prompts, and/or triggers such as covert challenges, prompts, and/or triggers as described herein.

FIG. 6 depicts a system diagram of an example a device such as a wireless transmit/receive unit (WTRU) that may be used to implement the systems and methods described herein.

FIG. 7 depicts a block diagram of an example device such as a computing environment that may be used to implement the systems and methods described herein.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

Systems and/or methods for authenticating a user (e.g., active authentication) of a device may be provided. For example, a user may not have a passcode and/or password active on his or her device and/or the user may not lock his or her device after unlocking it. The user may then leave his or her phone unattended. While unattended, an unauthorized user may seize the device thereby compromising content on the device and/or subjecting the device to harmful or unauthorized actions. To help reduce such unauthorized use, the device may use biometric information including facial recognition, fingerprint reading, pulse, heart rate, body temperature, hold pressure, and/or the like and/or behavior characteristics including, for example, website interactions, application interactions, and/or the like to determine whether the user may be an authorized or unauthorized user of the device.

The device may also use actions of a user to determine whether the user may be an authorized or unauthorized user. For example, the device may record typical usage by an authorized user and may store such use in a profile. The device may use such information to learn a typical behavior of the authorized user and may further store that behavior in the profile. While monitoring, the device may compare the learned behaviors with the actual behavior of the user of the device to determine whether there may be an intersection (e.g., whether the user may be performing actions he or she typically performs). In an example, a user may be an authorized user if, for example, the actual behaviors being received and/or being invoked with the device may be consistent with typical or learned behaviors of an authorized user (e.g., that may be included in the profile).

The device may also prompt or trigger actions to a user to determine whether the user may be an authorized or unauthorized user. For example, the device may trigger messages and/or may direct a user to different applications or websites to determine whether the user reacts in a manner similar to an authorized user. In particular, in an example, the device may bring up a website such as a sports site, for example, typically visited by an authorized user. The device may monitor to determine whether the users visits sections of the website typically accessed by an authorized user or accesses portions of the website not typically visited by the user. The device may use such information by itself or with additional monitoring to determine whether the user may be authorized or unauthorized. In an example, if a user may be unauthorized based on the monitoring by the device, the device may lock itself to protect content thereon and/or to reduce harmful actions that may be performed on the device.

As such, in examples described herein, active authentication on a device such as a mobile device may use or include meta-reasoning, user profile adaptation and discrimination, change detection using an open set transduction, and/or adaptive and covert challenge-response authentication. User profiles may be used in the active authentication. Such user profiles may be defined using biometrics including, for example, appearance, behavior, a physiological and/or cognitive state, and/or the like.

According to an example, the active authentication may be performed while the device may be unlocked. For example, as described herein, a device may be unlocked and, thus, ready for use when a user may initiate a session using a password and/or passcode (e.g., a legitimate login ID and password) for authentication. Once the device may be engaged and/or enabled, the device may remain available for use by an interested user whether the user may be authorized and/or legitimate, or not. As such, after unlocking the device, unauthorized users may improperly obtain “hijack” access to the device and its (e.g., implicit and explicit) resources, possibly leading to nefarious activities (e.g., especially if adequate oversight and vigilance after initial authentication may not be enforced). The use of meta-reasoning among a number of adaptive and discriminative monitoring methods for active authentication, using a principled flow of control, may be used as described herein to enable authentication after the device may be unlocked, for example, and/or to verify on a continuous basis that a user originally authenticated may be the actual user in control of the device.

The adaptive and covert aspect of active authentication may adapt to one or more ways a legitimate or authorized user may engage with the device, for example, over time. Further, the adaptive and covert aspect of the active authentication may use or deploy smart challenges, prompts, and/or triggers that may intertwine exploration and exploitation for continuous and usually covert authentication that may not interfere with normal operation of the device. The active (“exploratory”) aspect may include choosing how and when to authenticate and challenge the user. The “exploitation” aspect may be tuned to divine the most useful covert challenges, prompts, or triggers such that future engagements may be better focused and effective. The smart (“exploitation”) aspect may include or seek enhanced authentication performance using, for example, a recommender system such as strategies, e.g., user profiles (“contents filtering”) and/or crowd out sourcing (“collaborative filtering”), on one side, and trade-offs between A/B split testing and Multi-Arm Bandit adaptation as described herein. In examples, the systems or architecture and/or methods described herein may have characteristic of autonomic computing and its associated goals of SELF healing, configuration, protection, and optimization.

Using an active and continuous authentication may counter security vulnerabilities and/or nefarious consequences that that may occur with an unauthorized user accessing the device. To counter the security vulnerabilities and/or nefarious consequences, explicit and implicit (“covert”) authentication and re-authentication may be performed in an example.

Covert re-authentication may include one or more characteristics or prongs. For example, cover re-authentication may be subliminal in operation (e.g., under the surface or may occur unbeknownst to the user) as it may not interfere with a normal engagement of the device for one or more of the legitimate users. In particular, it may avoid making the current user, legitimate or not, aware of the fact that he or she may be monitored or “watched over” by the device.

Further, in covert re-authentication, covert challenges, prongs, and/or triggers may pursue their original charter, that of observing user responses that discriminate between legitimate user (and his profiles) and imposters. This may be characteristic of generic modules that may seek to discriminate between normal and abnormal behavior may be described herein (e.g., below). Using generic modules and/or A/B split (multi) testing (“randomized controlled experiments”) that may be used for web design and marketing decisions, covert re-authentication may attempt to maximize the reciprocal of the conversion rate, or in other words may enable or seek to find covert challenges that may not trigger “click” like distress activities. Rather, in an example, such challenges may uncover reflexive responses and/or reactions that clearly disambiguate between the legitimate and/or authorized user and an imposter (e.g., an unauthorized user).

Alternatively or additionally, the device may determine what or different levers (e.g., challenges, prompts, and/or triggers) to pull and in what order using Multi-Arm Bandit adaptation. This may occur or be performed using collaborative filtering and/or crowd outsourcing to anticipate what the normal biometrics such as appearance, behavior, and/or state, should be for the legitimate user as described herein. With such filtering and/or outsourcing, the device may leverage and/or use user profiles such as legitimate or authorized user profiles that may be updated upon proper and successful engagements with the device. Covert re-authentication (e.g., that may be performed on the device) may alternate between A/B (multi-testing) and Multi-Arm Bandit adaptation as it may adapt and evolve challenge-response, prompt-response, and/or trigger-response pairs. The determination, for example, by the device between A/B testing and Multi-Arm Bandit adaptation may be a trade-off between loss in conversion due to poor choices made on challenges and/or the time it takes to observe statistical significance on the choices made.

According to an example, active authentication, which may expand on traditional biometrics, may be tasked to counter malicious activity such as an insider threat (“traitors”) attempting exfiltration (“removal of data by stealth”); identity theft (“spoofing to acquire a false identity”); creating and trafficking in fraudulent accounts; distorting opinions, sentiments, and markets campaigns; and/or the like. The active authentication may build its defenses by validating an identity of a user using his or her unique characteristics and idiosyncrasies through biometrics including, but not limited to, a particular engagement of applications and their type, activation, sequence, frequency, and perceived impact on the user.

Active authentication (e.g., or re-authentication) may be driven by discriminative, likelihoods and odds, and/or methods using change and intrusion detection, learning and updating user profiles using and self-organization (SOM) and vector quantization (VQ), and/or recommender systems using covert challenge and response authentication. Active authentication may enable normal use of mobile devices without much interruption and without apparent interference. The overall approach may be holistic as it may cover a mix of biometrics, e.g., physical appearance and physiology, behavior and/or activities such as browsing and/or engagements with the device including applications thereon; context-sensitive situational awareness and population demographics. Trade-offs between convenience, costs, performance, and risks, on one side, and interoperability among different devices owned by the same user, on the other side, may be considered. As such, meta-recognition may be used or provided to mediate between different detection modules using their feedback and interdependencies.

Authentication, identification, and/or recognition may include or use biometrics such as facial recognition. Such authentication, identification, and/or recognition using biometrics may include “image” pair matching such as (1-1) verification and/or authentication using similarity and a suitable (e.g., empirically derived) threshold to ascertain which matching scores may reveal the same or matching subject in an image pair. The “image” may include face biometrics as well as gaze, touch, fingerprints, sensed stress, a pressure at which the device may be held, and/or the like. Iterative verification may support (1-MANY) identification against a previously enrolled gallery of subjects. Recognition can be either of closed or open set type, with only the latter one including a reject “unknown” option, which may be used with outlier, anomaly, and/or imposter detection. For example, the reject option may be used with active authentication as it may report on unauthorized users. In examples, unauthorized users or imposters may not necessarily be known to the device or application thereon and, thus, may be difficult to model ahead of time. Further, recognition as described herein may include layered categorization starting with face detection (Y/N), continuing with verification, identification, and/or surveillance, and possibly concluding with expression and soft biometrics characterization. The biometric photos and/or samples that may be used for facial recognition may be two-dimension (2D) gray-level and/or may be multi-valued such as RGB color. The photos and/or samples may include dimensions such as (x, y) with x standing for the possibly multi-dimensional (e.g., a feature vector) biometric signature and y standing for the corresponding label ID.

Although biometrics such as facial recognition may be one method of evaluating or authentication a user (e.g., to determine whether the user may be authorized or unauthorized), biometrics may not be one hundred percent accurate, for example, due to a complex mix of uncontrolled settings, lack of interoperability, and a sheer size of the gallery of enrolled subjects. Uncontrolled settings may include unconstrained data collection that may lead to possible poor “image” quality, for example, due to age, pose, illumination, and expression (A-PIE) variability. This may be improved or addressed using a region and/or patch-wise Histogram of Oriented Gradients (HOG) and/or Local Binary Patterns (LBP) like representations. The possibility of denial and/or occlusion and deception and/or disguise (e.g., whether deliberate or not), characteristics of incomplete or uncertain information, uncooperative subjects and/or imposters, may be solved (e.g., implicitly) using cascade recognition including multiple block and/or patch-wise processing.

As the relation between behavior and intent may be noisy and may be magnified by deception, active authentication may evaluate, calculate, and/or determine alerts on a user's legitimacy in using the device, for example, to balance between sensitivity and specificity of the decisions taken subject to context and the expected prevalence and kind of threats. As such, active authentication may engage in adversarial learning and behavior using challenges to deter, trap, and uncover imposters (e.g., unauthorized users) and/or crawling malware. Challenges, prompts, and/or triggers may be driven by user profiles and/or may alter on the fly defense shields to penetrate or determine whether the user may be an imposter. These shields may increase uncertainty (“confusion”) for the user such that the offending side may be misled on the true shape or characteristics of the user profile and the defenses deployed by the device. The challenge for meta-reasoning introduced herein may be to approach adversarial learning using some analogue of autonomic computing.

Active authentication may have access to biometric data streams during on-line processing. For example, intrusion detection of imposters or unauthorized users that have “hijacked” the device may be performed with biometric data. The biometric data may include face biometrics in one example. Face biometrics may include 2D (e.g., two-dimensional) normalized face images following face detection and normalization. For example, an image of a current user of the device may be taken by the device. The face in the image may be detected and normalized using any suitable technique and such a detected and/or normalized face may be compared with similar data or signatures of faces of authorized users. If a match may be determined or detected, the user may be authorized. Otherwise, the user may be deemed unauthorized or suspicious. The device may then be locked upon such a determination in an example. Alternatively or additionally, other information may be gathered and parsed as described herein (e.g., the device may pose challenges, triggers, and/or prompts and/or may gather other usage or biometric information) and may be weighed together with, for example, the face biometrics to determine whether a user of the device may be authorized.

For example, as described herein, the user representation, however, has access beyond face appearance and subject behavior or other traditional biometrics. There may also be context about the use of the device such as internet access, email, applications activated and their sequencing, and/or the like. The representation may encompass a combination of such information. The representation may further use or include prior and current user engagements, including user profiles learned over time and domain knowledge about such activities and expected (e.g., reactive) human behaviors. This may motivate or encourage the use of discriminative methods driven by likelihoods or odds and/or Universal Background Model (UBM) models as discussed herein.

As described herein, active authentication during an ongoing session may further include the use of covert challenges, prompts, or triggers and (e.g., implicit) user response to them, with the latter similar to, for example, a recommender system. In examples, the challenges, prompts, or triggered may be activated, for example, if or when there may be uncertainty on a user's identity, with a challenge, prompt, or trigger and an expected response thereto used to counter spoofing and remove ambiguity and/or uncertainty on a current user's identity.

According to examples, discriminative methods as described herein may avoid estimating how data may be generated and instead may focus on estimating posteriors in a fashion similar to the use of likelihood ratios (LR) and odds. An alternative generative and/or informative approach for 0/1 loss may assign an input x to the class k e K for whom the class posterior probability P (y=k|x) may be as follows

P(y=k|x)=P(x|y=k)P(y=k)/Σ_{—n}P(x|y=m)P(y=m)

and may yield a maximum. The corresponding Maximum A-Posterior (MAP) decision may use access to the log-likelihood P_{θ}(x, y). The parameters θ may be learned using maximum likelihood (ML) and a decision boundary may be induced, which may correspond to a minimum distance classifier. The discriminative approach may be more flexible and robust compared to informative and/or generative methods as fewer assumptions may be made.

The discriminative approach may also be more efficient compared to a generative approach, as it may model directly the conditional log-likelihood or posteriors P_{θ}(y|x). The parameters may be estimated using ML. This may lead to the following λₖ (x) discrimination function

λₖ(x)=log [P(y=k|x)/P(y=K|x)].

Such an approach may be similar to the use of the Universal Background Model (UBM) for LR definition and score normalization. The comparison and/or discrimination may take place between a specific class membership k and a generic distribution (over K) that may describe everything known about the (“negative”) population at large, for example, imposters or unauthorized users.

Boosting may be a medium that may be used to realize robust discriminative methods. The basic assumption behind boosting may be that “weak” learners may be combined to learn a target (e.g., class y) concept with probability 1−η. Weak learners that may be built around simple features such as biometric ones herein may learn to classify at a rate or probability better than chance (e.g., with probability ½+η for η>0). Adabost may be one technique that may be used herein. AdaBoost may work by adaptively and iteratively re-sampling the data to focus learning on exemplars that the previous weak (learner) classifiers could not master, with the relative weights of misclassified exemplars increased (“refocused”) in an iterative fashion. AdaBoost may include choosing T components hₜ to serve as weak (learner) classifiers and using their principled weighted combination as separating hyper-planes that may define a strong H classifier. AdaBoost may converge to the posterior distribution of y conditioned on x, and the strong but greedy classifier H in the limit may become the log-likelihood ratio test characteristic of discriminative methods.

Multi-class extensions for AdaBoost may also be used herein. The multi-class extensions for AdaBoost may include AdaBoost.M1 and .M2, the latter one used to learn strong classifiers with the focus now on difficult exemplars to recognize ID labels and/or tags hard to discriminate. In examples, different techniques may be used or may be available to minimize, for example, a Type II error and/or maximize power (1−β) of the weak learners. As an example, during cascade learning each weak learner (“classifier”) may be trained to achieve (e.g., a minimum acceptable) hit rate (1−β) and (e.g., a maximum acceptable) false alarm rate a. Boosting may yield upon completion the strong classifier H(x) as an ensemble of biometric weak (learner) classifiers. According to an example, the hit rate after T iterations may be (1−β)^{T} and the false alarm may be a^{T}.

A discriminative approach that may be used herein may be Random Boost. Random Boost may have access to user engagements and features of a session representation may include. Radom Boost may select a random set of “k” features and assembly them in an additive and discriminative fashion suitable for authentication. In an example, there may be several profiles owned by a legitimate user (m=1, . . . , M−1) and a generic UBM profile (m=M) that may cover the other users in the general population. Random Boost may include a combination of the Logit Boost and bagging-like algorithms. Random Boost may be similar or identical to Logit Boost with the exception that, similar to bagging, a randomly selected subset of features may be considered for constructing each stump (“weak learner”) that may augment the ensemble of classifiers. The use of random subsets of features for constructing stumps and/or weak learners may be viewed as a form of random subspace projection. The Random Boost model may implement or use an additive logistic regression model where the stumps may have access to more features than the standard Logit Boost algorithm. The motivation and merits for Random Boost may come from the complementary use of bagging and boosting or equivalently of re-sampling and ensemble methods. Each profile m=1, . . . , M−1 may be compared and/or discriminated against the UBM profile m=M, for example, using the equivalent of one against all with the winner-takes-all determining the kind of user in control of the device, that is, whether the user may be legitimate and authorized or an imposter and unauthorized. The winner-takes-all (WTA) may corresponds to that user profile that earns the top score and for whom the odds may be greater, for example, than other profiles. The user based on such a profile may be either known as legitimate or not. For example, WTA may determine or find a user profile (e.g., a known user profile) that may be closest to a profile of actions, interactions, uses, biometrics, and/or the like currently experienced by or performed on the device. Based on such a match, the user may be determined (e.g., by the device) as legitimate or not (e.g., if the profile being experienced matches the profile of an authorized or legitimate user, it may be determined the user may be legitimate or authorized and not an imposter or an unauthorized use and vice versa). According to an example, the user not being legitimate or authorizes may indicate the user may be an imposter. WTA sorts the matching scores and picks that one that indicates greatest similarity.

According to an example, each interactive session between a user and a device (e.g., a user-device interactive session) may captures biometrics such as face biometrics and/or may store or generate a record of activities, behavior, and context. The biometrics and/or records may be captured in terms of one or more time intervals, frequencies, and/or sequencing, for example, applications activated and commands executed. Active authentication may use the captured biometrics and/or records as a detection task to model and/or determine an unauthorized use of the device. This may include change or drift (e.g., when compared to a normal appearance and/or practice that may be traced to a legitimate or authorized user of the device) to indicate an anomaly, outlier, and/or imposter detection. As such, pair-wise matching scores may be calculated between consecutive face images and an order or sequencing of activities the user may have engaged in may be recorded and analyzed using strangeness or typicality and p-values that may be driven by transduction (as described herein, for example, below) and non-parametric tests on an order or rankings observed, respectively. Non-parametric tests on an order of activities may include or use a Weighted Spearman's foot rule, for example, that may estimate the Euclidean or Manhattan distance between permutations), a Kendal's tau that may count the number of discordant pairs, a Kolmogorov—Smirnov (KS) or Kullback-Leibler (KL) divergence, for example, to estimate the distance between two probability distributions, and/or a combination thereof. Change and drift may be further detected using a Sequential Probability Ratio Test (SPRT) or exchangeability (e.g., invariance to permutations) and martingale as described herein later on.

Transduction may be a method used herein to perform discrimination using both labeled (“legitimate or authorized user”) and unlabeled (“probing”) data that may be complementary to each other for, for example, change detection. Transduction may implement or use a local estimation (“inference”) that may move (“infer”) from specific instances to other specific instances. Transduction may select or choose from putative identities for unlabeled biometric data and, in an example, the one that may yield the largest randomness deficiency (i.e., the most probable ID). Pair-wise image matching scores may be evaluated and ranked using strangeness or typicality and p-values. The strangeness may measure a lack of typicality (e.g., for a face or face component) with respect to its true or putative (assumed) identity ID label and the ID labels for the other faces or parts thereof. According to an example, the strangeness measure αᵢ may be the (likelihood) ratio of the sum of the k nearest neighbor (kNN) similarity distances d from the same label ID y divided by the sum of the kNN distances from the other labels ( [symbol] y) or the majority negative label. The smaller the strangeness, the larger its typicality and the more probable its (putative) label y may be. The strangeness facilitates both feature selection (similar to Markov blankets) and variable selection (dimensionality reduction). The strangeness, classification margin, sample and hypothesis margin, posteriors, and odds, may be related via a monotonically non-decreasing function, with a small strangeness amounting to a large margin.

The p-values may compare (“rank”) the strangeness values to determine the credibility and confidence in the putative label assignments made. The p-values may resemble their counterparts from statistics but may not be the same. They may be determined according to the relative rankings of putative label assignments against each one of the known ID labels. The p-value construction, where l may be the cardinality of the gallery set or number of subjects known such as T, may be a valid randomness deficiency approximation for some putative label y to be assigned to a new exemplar (e.g., face image or user profile) e with p_{y}(e)=#(i: aᵢ≧a^{y}_{new})/(l+1). Each biometric (“probe”) exemplar e with putative label y and strangeness a^{y}_{new} may recalculate, if necessary, the strangeness for the labeled exemplars (e.g., when the identity of their k nearest neighbors may change due to the location of (the just inserted new exemplar) e). In an example, the p-values may assess the extent to which the biometric data supports or may discredit the null hypothesis H₀ for some specific label assignment.

An ID label may be assigned to yet untagged biometric probes. The ID label may corresponds to a label that may yield a maximum p-value across the putative label assignments attempted. This p-value may define a credibility of the label assigned. If the credibility may not be high or large enough (e.g., using a priori threshold determined via, for example, cross-validation) the label may be rejected. The difference between top choices or p-values (e.g., the top two) may be further used as a confidence value for the label assignment made. In an example, the smaller the confidence, the larger the ambiguity may be regarding the proposed prediction determined or made on the label. Predictions may, thus, not be bare, but associated with specific reliability measures, those of credibility and confidence. This may assist or facilitate both decision-making and data fusion. It may also assist or facilitate data collection and evidence accumulation using, for example, active learning and Querying (“probing”) By Transduction (QBT). According to an example (e.g., when the null hypothesis may be rejected for each ID label known), the device (or a remote system in communication with the device that may be used for biometric recognition) may determine or decide that an unlabeled face image may lack or not have a mate or match and it may respond to the query, for authentication purposes, as “none of the above,” “null,” and/or the like. This may indicate or declare that a face or other biometrics and/or a chain of activities on record for an ongoing session may be too ambiguous for authentication. In such an example, a device (or other system component) may not be able to determine or decide whether a current user in an ongoing session may be a legitimate owner (e.g., a legitimate or authorized user) or imposters (e.g., an unauthorized user) being in charge of the device and additional information may be needed to make such a determination. To gather such additional information, forensic exclusion with rejection that may be characteristic of open set recognition may be performed and/or handled by continuing to gather data, possibly using covert challenges.

In an example, the p-values that may be calculated or computed using the strangeness measure may be (e.g., essentially) a special case of the statistical notion of p-value. A sequence of random variables may be exchangeable if for a finite subset of the random variable sequence (e.g., that may include n random variables) a joint distribution may be invariant under a permutation of the indices of the random variable. A property of p-values computed for data generated from a source that may satisfy exchangeability may include p-values that may be independent and uniformly distributed on [0, 1]. According to an example (e.g., when the observed stream of data points may no longer be exchangeable), the corresponding (“recent innovations”) p-values may have smaller value and therefore the p-values may no longer be uniformly distributed on [0, 1]. This may be due to or result from the fact that observed data points such as newly observed data points may be likely to have higher strangeness values compared to those for the previously observed data points and, as such, their p-values may be or become smaller. The departure from the uniform distribution may suggest that an imposter or unauthorized user rather than a legitimate owner or authorized user may be in charge or in possession of the device.

One further notes that the skewness, a measure of the degree of asymmetry of a distribution, deviates from close to zero (for uniformly distributed p-values) to more than 0.1 for the p-value distribution when a model change may occur. Skewness may also be calculated or determined. In particular, the skewness may be S=(E[X−μ]³)/σ³, where μ and σ may be the mean and the standard deviation of the random variable X and/or may be small and stable (e.g., when there may be no change). While skewness may measure a lack of symmetry relative to the uniform distribution, a kurtosis K=(E[X−μ]⁴)/σ⁴−3 may measure whether the data may be peaked or flat relative to a normal distribution. Both the skewness and kurtosis may be estimated using histograms and optimal thresholds for intrusion detection may be empirically established.

Challenge and response handshake and/or mutual authentication exchange schemes, such as Open Authentication (OATH), may be provided and/or used. Open Authentication (OATH) may be an open standard that may enable strong authentication for devices from multiple vendors. Such schemes or authentication, in an example, may work by sharing secrets and may be expanded and/or used as described herein. For example, a challenge, prompt, and/or trigger and a response thereto may be covert or mostly covert (e.g., rather than open), random, and/or may not be eavesdropped. Further, an appropriate or suitable interplay between a challenge, prompt, and/or trigger and a response thereto may be subject to learning, for example, via hybrid recommender systems that may include secrets related to known and/or expected user behavior. Additionally, a challenge-response, prompt-response, and/or trigger-response scheme as described herein may be activated by a closed-loop control meta-recognition module whenever there may be doubt on the identity of the user. In an example, a covert challenge-response, prompt-response, and/or trigger-response handshake may be a substitute or an alternative for passwords or passcodes and/or may be subliminal in its use. In examples, challenges, prompts, and/or triggers may enable or ensure that a “nonce” characteristic, i.e., each challenge, prompt, or trigger may be used once during a given session. The challenges, prompts, and/or triggers may be driven by hybrid recommender systems where both contents-based and collaborative filtering may be engaged. Such a hybrid approach may perform better in terms of cold start, scalability, and/or sparsity, for example, compared to stand alone contents-based or collaborative type of filtering.

The scheme described herein may further expand on an “active” element of authentication. The active element may include continuous authentication and/or similar to active learning, it may not be a mere passive observer but rather an active one. As such, in an example, the active element may be engaged and ready to prompt the user with challenges, prompts, and/or triggers and may figure out from one or more responses if a user may be a legitimate or authorized user or an impostor or unauthorized user that may have hijacked or have access to the device. The active element may explore and exploit a landscape characteristic of proper use of the device by its legitimate or authorized user to generate effective and robust challenges, prompts, and/or triggers. This may be characteristic of closed-loop control and may include access to legitimate or authorized user profiles that may be subject to continuous adaptation as described herein. According to an example, the effectiveness and robustness of the active authentication scheme and/or active element described herein may be achieved using reinforcement learning driven by A/B split testing and Multi-Arm Bandit Adaptation (MABA), which may include a goal to choose in a principled fashion from some repertoire of challenge, prompt, and/or trigger and response pairs.

Challenges, prompts, and/or triggers may be provided, sent, and/or fired by a meta-recognition module. The meta-recognition module or component may be included in the device (or a remote system) and may interface and mediate between the methods described herein for active authentication. The purpose for each challenge, prompt, and/or trigger or a combination thereof may be to disambiguate between a legitimate or authorized user and imposters. Expected responses to challenges that may be modeled and learned using a recommender system may be compared against actual responses to resolve an authentication and determine whether a user may be legitimate or authorized or not. The recommender system or modules in the device, for example that may be implemented or used as described herein may combine contents-based and collaborative filtering. The contents-based filtering may use or may be driven by user profiles that undergo continuous adaptation upon completion of proper engagements (e.g., legitimate) with the device. The collaborative filtering may be memory-based, may be driven by neighborhood relationships to similar users and a ratings matrix (e.g., an activity—based and frequency ratings matrix) associated with the similar users, and/or may use or draw from crowd outsourcing.

Contents-based and collaborative filtering support adaptation from the observed transactions that may be performed or executed by a legitimate or authorized user or owner of the device and imposters or unauthorized users that may be drawn or sampled from a general population. In examples, items or elements of the transactions include one or more applications used, device settings, web sites visited, types of information accessed and/or processed, the frequency, sequencing, and type of interactions, and/or the like. One or more challenges, prompts, and/or triggers and/or responses thereto may have access to and can access to information including behavioral and physiological features captured in a non-intrusive or subliminal fashion during normal use by the sensors the device comes equipped with such as micro-electronic mechanical systems (MEMS), other sensors and processors, and/or the like. Examples of such information may include key—stroke dynamics, odor, cardiac-rhythm (ECG/PQRST). According to an example, some of the information such as heart rate variability, stress, and/or the like may be induced in response to covert challenges. One can further expand on this similar to the use of biofeedback.

Transactions may be used as clusters in one or more methods described herein and/or in their raw form. Regardless of whether clusters or the raw form may be used, at a time instance during an ongoing engagement between a user and a device, a recommendation (“prediction”) may be made or determined about would should happen or come next during engagement of the device by a legitimate or authorized user. For example, a control or predication component or module in the device may determine, predict, or recommend an appropriate action that should come next when the device may be used by an authorized or legitimate user.

The device (e.g., a control module or component) may make or provide an allowance for new engagements that are deemed proper and not illicit and may update existing profiles accordingly and/or may create additional profiles for novel biometrics being observed including appearance and/or behavior. According to an example, user profiles may be continuously updated using self-organization maps (SOM) and/or vector quantization (VQ), that may partition (“tile”) the space of either individual legal engagements or their sequencing (“trajectories”) as described in the methods herein. In active authentication, flexibility may be provided in coping with a variability of sequences of engagements. Such a flexibility may result from Dynamic Time Warping (DTW) to account for shorter or longer time sequences (e.g., that may be due to user speed) but of the same type of engagement

Recommendations may fail to materialize for a legitimate or authorized user. For example, a user of the current session or currently using the device may not react or use the device in a manner similar to the recommendations associated with a legitimate or authorized user. In such an example, a control meta-recognition module or component as described herein that may be included in the device may determine or conclude that the device may have been possibly hijacked and covert challenges, prompts, and/or triggers as described herein may be prompted, provided, or fired, for example, to ascertain the user's identity. The active authentication and methods associated therewith may store information and provide incremental learning including information decay of legitimate or authorized user profiles. As such, the active authentication described herein may be able to adapt to changes in the legitimate or authorized user's use of the mobile device and his or her preferences.

The active authentication methods described herein may cause as little as possible interference for a legitimate or authorize user, but may still provide mechanisms that may enable imposers or unauthorized users to be locked out. As such, in examples, covert challenges, prompts, and/or triggers and responses thereto may be provided by recommender systems similar to case-based reasoning (CBR). Contents-based filtering may leverage an actual engagement or use of a device by each legitimate or authorized user for making personalized recommendations. Collaborative filtering may leverage crowd outsourcing and neighborhood methods, in general, and clustering, ratings or rankings, and similarity, for example, to learn about others including imposters or unauthorized users and to model them (e.g., similar to Universal Background Models (UBM)).

The interplay between the actual use of the device, covert challenges, prompts, and/or triggers and responses that may be driven by recommender systems (of either contents-based or collaborative filtering type) may be mediated throughout by meta-recognition using gating functions such as stacking, and/or mixtures of experts such as boosting. The active authentication scheme may be further expanded by mutual challenge-response authentication, with both the device and user authenticating and re-authenticating each other. This may be useful, for example, if or when the authorized user of the device suspects that the device has been hacked and/or compromised.

According to an embodiment, a method for meta-recognition may be provided and/or used. Such a method may be relevant to both generic multi-level and multi-layer data fusion in terms of functionality and granularity. Multi-level fusion may include features or components, scores (“match”), and detection (“decision”), while multi-layer fusion may include modality, quality, and/or one or more algorithms. The algorithms that may be used may include those of cohort discrimination type using random boost, intrusion detection using transduction, user profiles adaptation, and covert challenges for disambiguation purposes using recommender systems, A/B split testing, and/or multi-arm bandit adaptation (MABA) as described herein.

Expectations and/or predictions, modeled as recommendations, may be compared against actual engagements, thought of as responses. Recommender systems that may be included in the device or an external system may use or provide contents-based filtering using user profiles and/or collaborative filtering using existing relationships learned from diverse population dynamics. Active authentication using Random Boost or Change Detection as described herein may learn and employ user profiles. This may correspond to recommender systems of contents-based filtering type. Active authentication using covert challenges, prompts, and/or triggers and responses may use collaborative filtering, A/B split testing, and MABA. Similar to natural language and document classification, Latent Dirichlet Allocation (LDA) may provide additional ways to inject semantics and pragmatics for enhanced collaborative filtering. LDA seeks to identify “topics” such as hidden topics that may be shared by different users, using matrix factorization and Dirichlet priors on topics and events' “vocabulary.”

Meta-recognition (e.g., or meta-reasoning) that may be used herein may be hierarchical in nature, with parts and/or components or features inducing weak learners (“stumps”) whose relative performance may be provided by transduction using strangeness and a p-value while an aggregation or fusion may be performed using boosting. In such an example, the strangeness may be a thread used to implement effective face representations, on one side, and boosting such as model selection using learning and prediction for recognition, on the other side. The strangeness, which may implement the interface between the biometric representation (including attributes and/or components) and boosting, may combine or use the combination of merits of filter and wrapper classification methods.

In an example, a meta-recognition method (e.g., that may include one or more ensemble methods) may be provided and/or performed in a device such as a mobile device for active authentication as described herein. Meta-recognition herein may include multi-algorithm fusion and control and/or may enable or deal with post-processing to reconcile matching scores and sequence the ensuing flow of computation accordingly. Using meta-recognition, adaptive ensemble methods or techniques that may be characteristic of divide—and—conquer strategies may be provided and/or used. Such ensemble methods may include a mixture of experts and voting schemes and/or may employ or use diverse algorithms or classifiers to inject model variance leading to better prediction. Further, in meta-recognition, active control may be actuated (e.g., when uncertainty on user identity may arise) and/or explore and exploit strategies may be provided and/or used. This may be implemented herein using A/B split testing and multi-arm bandit adaptation (MABA) where challenges, prompts, and/or triggers such as covert challenges, prompts, and/or triggers may be selected for or toward active re-authentication. Meta-recognition described herein may also include or involve supervised learning and may, in examples, include one or more of the following: bagging using random resampling; boosting as described herein; gating (connectionist or neural) networks, possibly hierarchical in nature, and/or stacking generalization or blending, with the mixing coefficients known as gating functions; and/or the like.

User discrimination using random boost and/or user profile adaption may be performed in the meta-recognition and may be characteristic of contents-based filtering. Further, collaborative filtering may be performed and/or cover challenges, prompts, and/or triggers may be provided. Contents-based filtering may be supported by user profile adaptation as described herein. Meta-recognition may be performed in the background, for example, while a current user may engage a device.

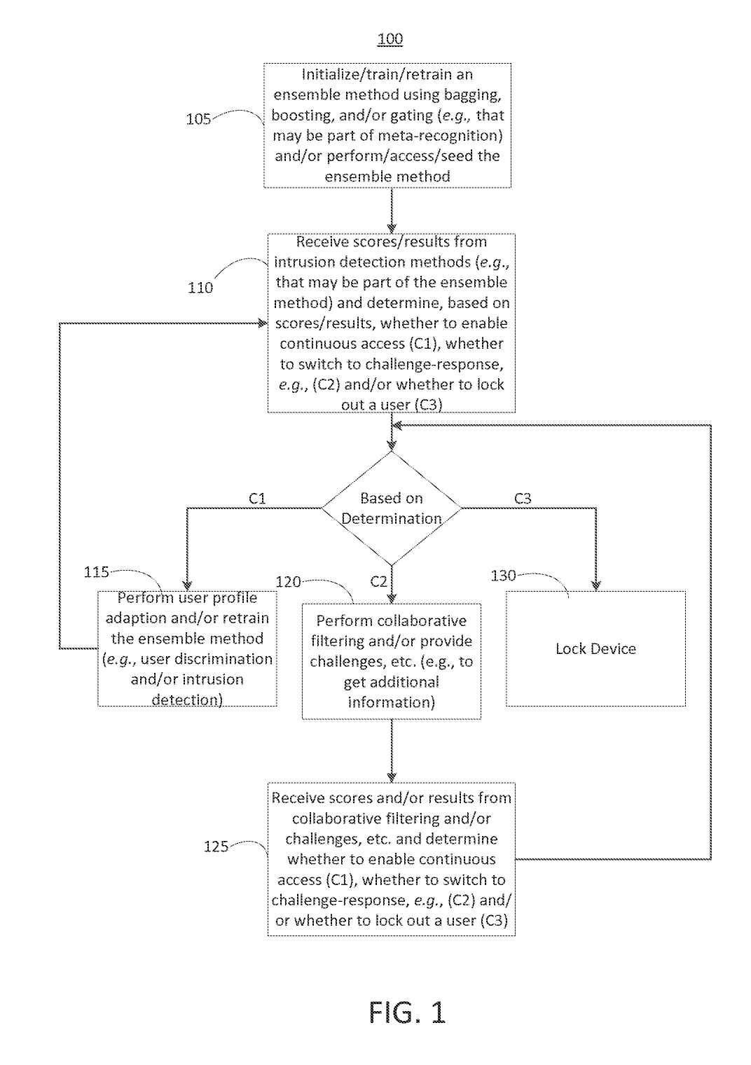

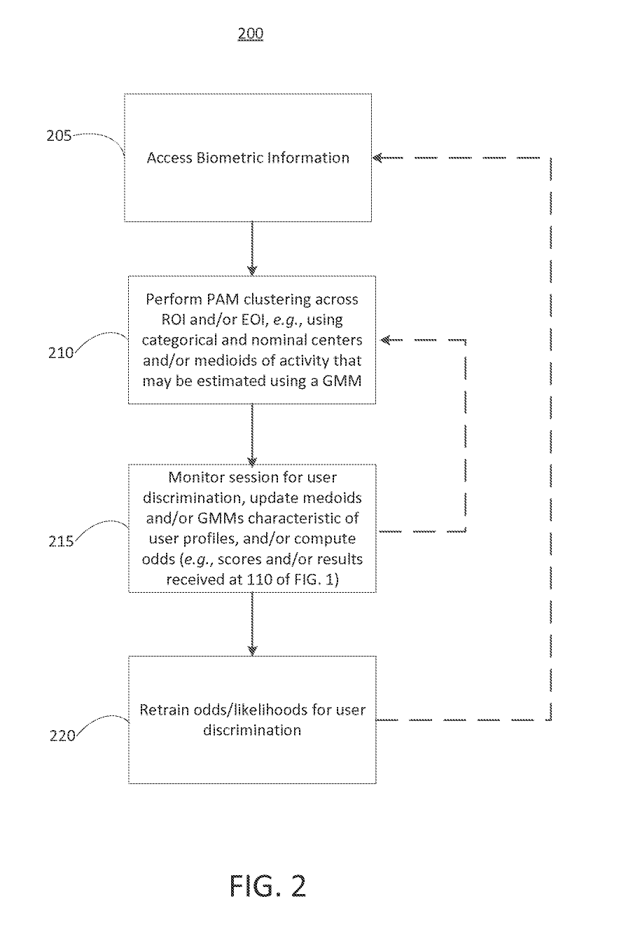

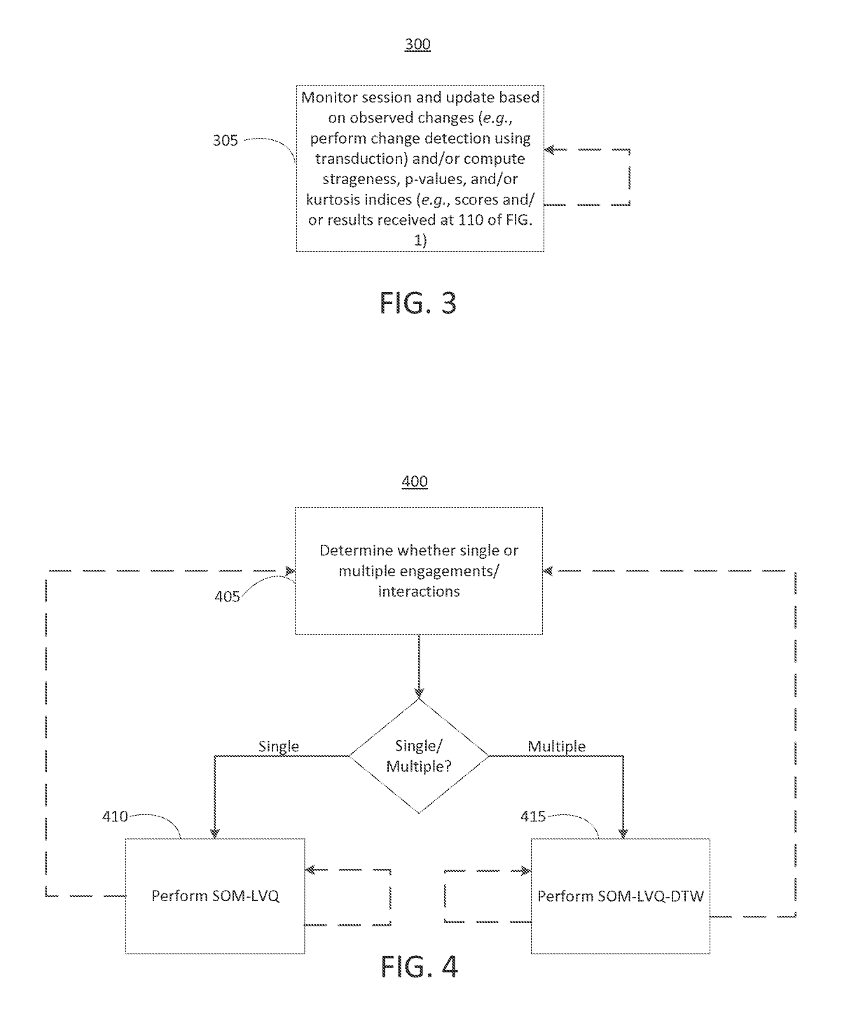

FIG. 1 illustrates an example method 100 for performing meta-recognition (e.g., for active authentication). As shown, at 105, an ensemble method may be seeded and/or learned. For example, in method 100, a device may seed and/or learn an ensemble method (e.g., bagging, boosting, or gating network) coupled to user discrimination using random boost (e.g., such as method 200 described with respect to FIG. 2) and/or intrusion (“change”) detection using transduction (e.g., such as method 300 described with respect to FIG. 3). In an example, the device may seed and/or learn an ensemble method in terms of experts and/or relative weights at 105.

At 110, scores or results may be received for the ensemble method and such scores may be evaluated or analyzed. For example, scores or results associated with user discrimination using random boost and/or intrusion (“change”) detecting using transduction methods described herein that may be activated and performed at the same time may be received. The scores may be analyzed or evaluated to determine or select whether to allow continuous access of the device by the user (C1), whether to switch to a challenge-response, prompt-response, and/or trigger-response re-authentication (C2), and/or whether to lock out the current user (C3). As such, the scores or results may be evaluated and/or analyzed (e.g., by the device) to choose between C1, C2, and C3 as described herein. The thresholds that may be used to choose between C1, C2, and C3 may be empirically determined (e.g., may be based on ground truth as experienced) and continuously adapted based on the actual use of the device. For example, the scores described herein may include or be compared with scores {s1, s2}. The scores s1 and/or s2 (i.e., {s1, s2} may assess the degree to which the device may trust the user. For example, in an embodiment, s1 may be greater than s2. The device may determine or use s1 as a metric or threshold for its trust with the user. For example, scores that may be greater than or equal to s1 may be determined to be trustful by the device and the user may continue (e.g., C1 may be triggered. Scores that may be less than s1, but greater than s2 may be determined to be less trustful by the device and additional information may be used to determine whether a user may be an impostor or not (e.g., C2 may be triggered including, for example, a challenge—response to the user). Scores that may be less than s2 may be determined to not be trustful to the device and the user may be locked out and deemed an imposter (e.g., C3 may be triggered).

At 115, based on the determination (e.g., at 110 and/or 125) that C1 should be selected and, thus, a legitimate or authorized user maybe in control of the device, user profile adaption (e.g., such as the method 400 described with respect to FIG. 4) may be performed. Further, at 115 (e.g., as part of C1), user discrimination using random boost and/or intrusion (“change”) detection using transduction may be retrained based on, for example, the most current interactions by the user that have been determined to be authorized or legitimate. The method 100 may then be executed or invoked to continue to monitor the user's behavior with the device. For example, as time goes on or passes, the device may record or observe a legitimate user and/or his or her idiosyncrasies. As a result of such observations or recordations, a profile of the user may be updated. Examples of such observations or recordations that may be determined or made by the device and used to update the profile (e.g., retrain user discrimination) may include one or more of the following: a legitimate user becoming familiar with the device and may be scrolling and/or reading faster; a user developing different or new habits such as reading news from one news sources rather than a different news source, for example, in the morning; a user behaving differently during the week compared to weekend such that the device may generate two profiles for the same legitimate user: legitimate.1 (“week”) profile and legitimate.2 (“weekend”) profile; and/or the like.

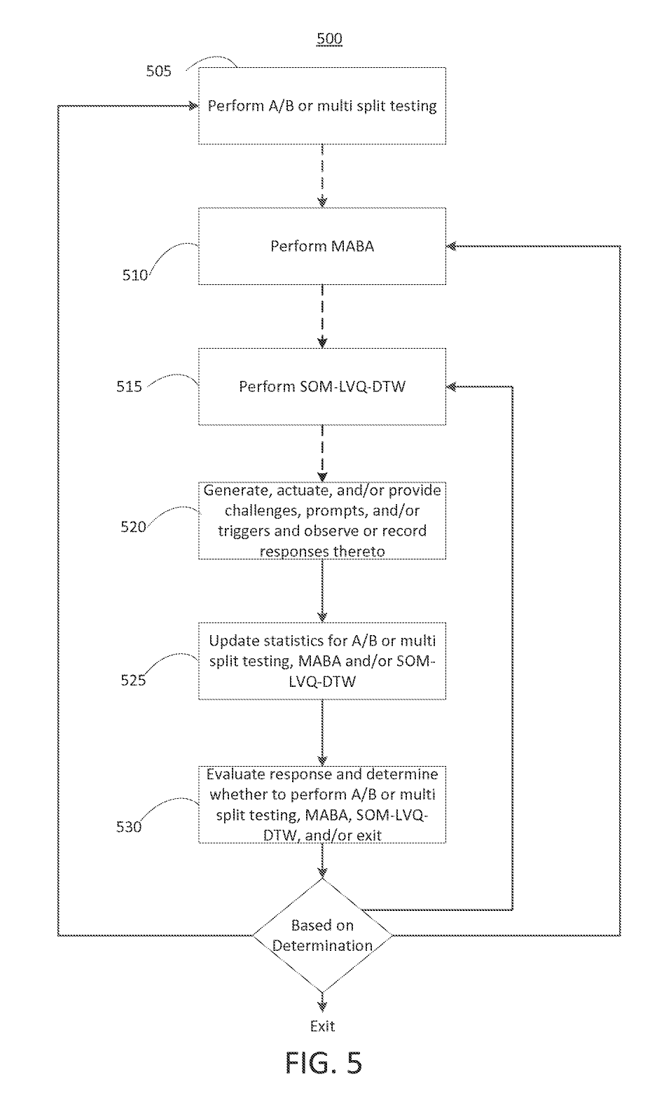

At 120, based on the determination (e.g., at 110 and/or 125) that C2 should be selected and additional information may need to be provided to determine whether user may be authorized or legitimate, collaborate filtering may be performed and/or covert challenges, prompts, and/or triggers may be provided (e.g., as descried with respect to the method 500 in FIG. 5). For example, at 120, seed and evolve A/B split testing and multi-arm bandit adaptation (MABA) for challenges, prompts, and/or triggers and responses thereto may be performed as described herein.

At 125, scores or results for the collaborative filtering and/or covert challenges, prompts, and/or triggers may be received and analyzed or evaluated. For example, scores or results associated with collaborative filtering and/or covert challenge, prompt, and/or trigger methods described herein may be received. The scores may be analyzed or evaluated to determine or select whether to allow continuous access of the device by the user (C1), whether to continue in a challenge-response, prompt-response, and/or trigger-response re-authentication (C2), and/or whether to lock out the current user (C3) as described herein, for example, above.

At 130, based on the determination (e.g., at 110 or 125) that C3 should be selected and, thus, the user may be an unauthorized user or imposter, the device may be locked. The device may stay in such a locked state until, for example, an authorized or legitimate user may provide the proper credentials such as a passcode or password as described herein. In an example, a user may stop or end use of the device and log out during the method 100.

FIG. 2 illustrates an example method 200 for performing user discrimination, for example, using random boost. For example, as described herein, active authentication may implement or perform repeated identification against M user profiles, with M−1 of them belonging to a legitimate or authorized owner or user, and the profile M characteristic of the general population, for example, a Universal Background Model (UBM), and possible imposters. Based on such information, user discrimination may be performed using random boost as described herein.

As shown, at 205, biometric information such as a normalized face image or a sensory suite may be accessed. According to an example, the biometric information such as the normalized face image may be represented using Multi-Scale Block LBP (MBLBP) histograms and/or any other suitable representation. An expression such as a face expression or micro-texture for each image may be used for coupling identity and/or inner states that may capture alertness, interest, and possibly cognitive state. The inner states may be a function of a user and interactions he or she may be engaged in and/or the result of or the response for covert challenges, prompts, and/or triggers provided by the device. User profiles that may be used herein may encode mutual information between block-wise Region of Interest (ROI) and Event of Interest (EOI) and/or physiological or cognitive (e.g., intent) states may be generated as bag of words, descriptors, or indicators for continuous and/or active re-authentication.

At 210, partitioned aggregated medoid (PAM) clustering may be performed across the ROI and/or EOI, for example, using categorical and nominal centers and/or medoids of activity that may be estimated using a Gaussian Mixture Model (GMM). Further, in an example (e.g., at 210), user profile models m=1, . . . , M−1 and Universal Background Model (UBM) for imposter class M may be determined or learned, for example, offline, to derive and/or seed a corresponding bag of words, descriptors, indicators, and/or the like and update them during real-time operation using (Learning) Vector Quantization (LVQ) and Self-Organization Maps (SOM) (e.g., as described in method 300 of FIG. 3). The coordinates for entries in bag of words, descriptors, indicators, and/or the like may span among others a Cartesian product C of, for example, context, access, and task including financial markets, application, and browsing. Additionally (e.g., at 210), random boost may be initialized using given priors on user profiles. Seeding, which may be the same or similar to initializing, may include training the system or device off-line to discriminate among the M models that may be used and learned as described herein. In an example, seeding may be initializing and may include selecting starting (“initial”) values for parameters that may be used by the methods or algorithms described herein.

At 215, an on-going session on the device (e.g., as part of user discrimination) may be continuously monitored and/or the medoids and/or GMMs characteristic of user profiles may be updated (e.g., as described in method 400 of FIG. 4). Each updated bag of words, descriptors, indicators, and/or the like may be used by random boost to compute one or more odds for user models (m=1, . . . , M−1) vis-á-vis UBM (m=M) (e.g., at 215). In an example, the odds that may be computed or determined may be provided to the meta-recognition such as the method 100 of FIG. 1 as part of the scores, for example.

At 220, discrimination odds and likelihoods for the method 200 (i.e., for user discrimination) may be retrained drawing from most recent engagements in the use of the mobile device that may be weighted more than previous engagements as appropriate during operation of the device by a legitimate or authorized user. In an example, a moving average of the engagements or interactions with the use of the device may be used to retrain the methods herein such as the method 200 including, for example, the discrimination odds and/or likelihoods. Further, according to an example, 215 and 220 may be looped and/or continuously performed during a session (e.g., until the user may be determined to be deemed to be an imposter or unauthorized user).

FIG. 3 illustrates an example method 300 for performing intrusion (“change”) detection using, for example, transduction as described herein. While Random Boost may be able to discriminate between a legitimate or authorized user and imposters, intrusion detection such as that performed by the method 300 may identify imposters while seeking for significant anomalies in the way particular bag of words, descriptors, and/or indicators may change across time. In an example, the method 300 may have access to representations computed in 205 and 210 of the method 200. Temporal change and evolution for inner states may be recorded using gradients and aggregates, with Regions of Interest (ROI) and Events of Interest (EOI) identified and described using bag of words, descriptors, and/or indicators as described herein. Continuous user authentication may be performed using transduction where a significance of an observed change may be provided, sent, or fed to (e.g., as part of the score or results) meta-recognition such as that described in the method 100 of FIG. 1.

At 305, the ongoing session on the device (e.g., as part of intrusion detection) may be continuously monitored and/or the bag of words, descriptors, and/or indictors may be updated using the observed changes as described herein. In an example, change detection on the bag of words, descriptors, and/or indicators may be performed using transduction determined, as described herein, by strangeness and p-values with skewness and/or kurtosis indices being continuously fed back to meta-recognition (e.g., as part of the scores or results in the method 100). In an example, 305 may be performed in a loop or continuously, for example, during a session until an imposter or unauthorized user may be detected.

FIG. 4 illustrates an example method 400 for performing user profile adaptation as described herein. The algorithms of interest for such user profile adaptation (e.g., that may be used in the method 400) may include vector quantization (VQ), learning vector quantization (LVQ), self-organization maps (SOM), and dynamic time warping (DTW). The algorithms may prototype and/or define an event space including, for example, corresponding probability functions that may include individual and/or sequences of engagements, in a fashion similar to clustering, competitive learning, and/or data compression (e.g., similar to audio codecs), in general, and/or k-means and expectation-maximization (EM), in particular. The algorithms used herein may provide both data reduction and dimensionality reduction. In an example, the underlying technique that may be used may include a batch or on-line Generalized Lloyd algorithm (GLA) with biological interpretation available for, for example, an on-line version. A cold start may be or may include, for example, lacking information on items and/or parameters (e.g., for whom not enough sufficient specific information has been gathered) and may affect such a GLA in terms of initialization and seeding. Different initializations for start (e.g., generic information on legitimate user given her demographics and/or soft biometrics verses a general population) and conscience mechanisms (e.g., even units describing the user profiles but not yet activated participate in updates) may be used to alleviate cold start. Cold start may be a potential problem in computer-based information systems or devices as described herein that may include a degree of automated data modeling. Specifically, it may include the system or device not being able to draw inferences for users or items from which the device may not have yet gathered sufficient information. Cold start may be addressed herein using some random values or experience-based or demographics-driven values such as a particular type of user such as a businessman or CEO spending 10 minutes each morning reading the news. Once user engages device for some time, the cold start values may be updated to reflect an actual user and use. Additionally, in an example, on-line learning that may be used herein may be iterative, incremental, and may include decay (e.g., an effect of updates that may decrease as time goes on to avoid oscillations) and forgetting (e.g., an early experience that may be weighted much less than most recent one to account for evolving user profiles as time goes on). According to an example, decay and forgetting may be examples of what may happen during retraining, for example, as time goes on, early habits may be weighted less or completely forgotten (e.g., if they may not be currently used).

Vector quantization (VQ) that may be used herein may be a standard quantization approach typically used in signal processing. The prototype vectors thereof may include elements that may capture relevant information about user activities and events that may take place during use of the device and/or may tile the event space into disjoint regions, for example, similar to Voronoi diagrams and Delaunay tessellation, using nearest neighbor rules. In an example, the tiles may correspond to user profiles, with the possibility of allocating some of the tiles for modeling the general population including imposters or unauthorized users. VQ may render itself to hierarchical scheme and may be suitable for handling high-dimensional data. In addition, VQ may provide matching and re-authentication flexibility as the prototypes may be found on tiles (e.g., an “own” tile) rather than discrete points (e.g., to allow variation in how the users behave under specific circumstances). As such, VQ may enable or allow for data correction (e.g., prototypes and tiles updates), for example, according to a level of quantization that may be used. Parameter setting and/or tuning may be performed for VQ. Parameter setting and/or tuning may use priors on the number of prototypes, both legitimate users, and the general population (e.g., UBM).

According to an example, self-organizing maps (SOM) or Kohonen maps may be involved in user profile adaptation (e.g., the method 400 of FIG. 4). SOM or Kohonen maps may be standard connectionist (“neural”) models that may be trained using unsupervised learning (“clustering”) to map multi-dimensional data to 1D or 2D maps for discrimination, summarization (e.g., similar to dimensionality reduction and multidimensional scaling), and visualization purposes. In an example, batch and/or on-line SOM may expand on VQ as such SOM may be topology preserving and/or may use neighborhood relations for iterative updating. Further, batch and/or online SOM may be nonlinear and/or a generalization of principal component analysis (PCA). Training may be performed (e.g., for such SOM) using competitive learning, similar to vector quantization.

According to an example, hybrid SOM may be used for user profile adaptation (e.g., in the method 400 of FIG. 4). Hybrid SOM may be available with SOM outputs that may be provided to or fed to a multilayer perceptron (MLP) for classification purposes using supervised learning similar to back-propagation (BP). Learning vector quantization (LVQ) may also be used (e.g., in the method 400). LVQ, which may be similar to hybrid SOM, may be a supervised version of vector quantization. LVQ training may move a winner-take-all (WTA) prototype that may be used by vector quantization closer to a probing data point if the data point may be correctly classified. To correctly classify a data point, the device or system may determine or figure out correctly between a legitimate user and imposter and/or between different user profiles that may belong to a user such as between week and weekend profiles of a user. In an example, a correct classification may include determining or figuring out which class (e.g., a ground truth class) a sample (e.g., the user) may belong to. LVQ training may also moves the WTA away when the data point may be misclassified. Both hybrid SOM and LVQ may be used to generate 2D semantic networks maps, where interpretation, meaning, semantics may be interrelated for classification and/or discrimination. Additionally, metrics that may be used for similarity may vary and/or may embed different notions of closeness (e.g., similar to Word Net similarity) including context awareness.

Dynamic time warping (DTW) may also be used in user profile adaptation (e.g., in the method 400). DTW may be a standard time series analysis algorithm that may be used to measure a similarity between two temporal sequences that may vary in shape, time or speed including, for example, spelling errors, pedestrian speed for gait analysis, and/or speaking speed or pause for speech processing. DTW may match sequences subject to possible “warping” using locality constraints and Levenshtein editing. In an example, self-organizing maps (SOM) may be coupled with dynamic time warping (DTW), with SOM and DTW being used for optimal class separation and obtaining time-normalized distances between sequences with different lengths, respectively. Such an approach may be used for both recognition and synthesis of pattern sequences. Synthesis may be of particular interest for generating candidate challenges, prompts, and/or triggers (e.g., in method 500 of FIG. 5).

As described herein, the method 400 may use SOM-LVQ and/or SOM-LVQ-DTW to update user profiles after singular or multiple engagements such as multiple sequential engagements, respectively. For example, as shown in FIG. 4, at 410, SOM-LVQ may be performed as described herein to update a user profile. The updated user profile may then be saved and used to determine whether a user may be authorized or legitimate and/or an impostor or unauthorized in a current or future sessions. As described herein, LVQ training may move a winner-take-all (WTA) prototype that may be used by vector quantization closer to a probing data point if the data point may be correctly classified. As such, updates of profiles corresponding to SOM units moved away or closer to the probe. Such moves redefine what the units stand for or represents (e.g., what are the new user profile prototypes and the Voronoi (“tile”) diagrams). For example, SOM-LVQ may move to update profiles such as prototypes (“average”) user profiles. Prototype user profiles may be multi-valued feature vectors with features that may characterize a prototype. For example, a user may spend time on device reading sports as one feature for both “week” (10 minutes) and “week-end” (20 minutes) legitimate user profiles. In an example, during training, the user may read sports for 7 minutes during the week. Using weighted average or similar the feature for “week” may be adjusted and/or may become closer to 7 and slightly away from 10. According to another or additional example, the user may read sports for 17 minutes during the week. The feature (e.g., 20 minutes) read during the weekend may be increased to say 26 to avoid future mistakes (e.g., as 17 may be closer to 20 than 10). Exact updating rule may exist and may include decay and similar techniques.

According to an example, SOM-LVQ may be performed for a single engagement or interaction with the device. For example, at 405, a determination may be made as to whether a single engagement or interaction or multiple engagements or interactions by a user may be performed on the device. If a single engagement or interaction may be performed on the device, SOM-LGW may be performed to update a user profile. In an example, 415 may be performed continuously or in a loop until a condition may be met such as, for example, a user may be determined to be an unauthorized user or imposter, multiple engagements or interactions may be performed, and/or the like.

As shown in FIG. 4, at 415, SOM-LVQ-DTW may be performed as described herein to update a user profile. The updated user profile may then be saved and used to determine whether a user may be authorized or legitimate and/or an impostor or unauthorized in a current or future sessions. For example, sequences of engagements and/or multiple interactions rather than single events may now modeled, SOM unit “prototypes” may encode sequences rather than single events, and matching between units and DTW may enable variability in the length of the sequences being matched and the relative length of the motifs making up the sequences. According to an example, SOM-LVQ-DTW may be performed for multiple engagements or interactions with the device. For example, at 405, a determination may be made as to whether a single engagement or interaction or multiple engagements or interactions by a user may be performed on the device. If multiple engagements or interactions may be performed on the device, SOM-LGW-DTW may be performed to update a user profile. According to an example, with SOM-LVQ-DTW, sequences of actions or interactions rather than individual and/or stand-alone features may be used (e.g., to move a profile as described herein). For example, the device may determine that weather, a news source, and sports may be what a user usually looks for in the morning. Such information may be used in performing SOM-GW-DTW to update the user profile. The relative time spent on each interaction may vary and/or speed of use or speech and such information may also be used. According to an example, DTW may take into account a variance on time spent on a particular interaction and/or such a speed. In an example, 415 may be performed continuously or in a loop until, for example, a condition may be met such as, for example, a user may be determined to be an unauthorized user or imposter, a single engagement or interaction may be performed, and/or the like.

FIG. 5 illustrates an example method 500 for performing collaborative filtering and/or providing challenges, prompts, and/or triggers such as covert challenges, prompts, and/or triggers as described herein. According to an example, the method 500 may have access to one or more transactions executed by an authorized or legitimate user of the device and by the general population that may include imposters. The items or elements that may be part of or that may make-up the transactions may include, among others, applications used, device settings, web sites visited, email interactions or types thereof, and/or the like. Transactions such as pair-wise transactions that may be similar to challenge-response pairs used for security purposes may be collected and either clustered (e.g., as described in the method 400 of FIG. 4) or used in raw form. During an ongoing session or engagement and/or interaction with the device, a recommendation or prediction such as a filtering recommendation or prediction may be determined or made about what “response” may come next (e.g., by an authorized or legitimate user). If or should a number of such recommendations fail to match or materialize those for a legitimate or authorized device user, the method 500 alone and/or, in combination, with the method 100 may conclude that the device may have been hijacked and should be locked. As described herein, the method 500 may enable incremental learning with decay that may allow it to adapt to changes in a legitimate or authorized user's preferences.

Collaborative filtering that may be characteristic of recommender systems may determine or make one or more predictions (e.g., in the method 500) as a “filtering” aspect about interests, interactions, engagements, or responses of a user by collecting preferences information from users, for example, as a “collaborative” aspect, in response to challenges, prompts, and/or triggers. The predictions or responses that may be for or specific to a user may leverage information coming from many users sharing similar preferences (“tastes”) for topics of interest (e.g., users that may have similar book and movie recommendations, respectively). The analogy between collaborative filtering and challenge-response such as covert challenge-response may be as follows. Transaction lists that may be traced to different users may be pair-wise matched. In an example, if an intersection may be larger than a threshold and/or size such as empirically found threshold and/or size, a recommendation list may be provided, determined, or emerge from the items appearing on one list but not on another list. This may be done in an asymmetric fashion with a legitimate or authorized user's current list on one side, and the other lists, on the other side. According to an example, the other lists may record and/or cluster a legitimate or authorized user's past transactions or an imposters or unauthorized user's (e.g., in a putative and/or negative database (DB) population) expected response or behavior to subliminal challenges. Collaborative filtering that may be used herein may be a mix of A/B split testing and multi-arm bandit adaptation.

A/B or multi split testing that may be used for on-line marketing may split traffic such that a user may experience different web page content on version A and version B, for example, while the testing on the device may monitor the user's actions to identify the version that may yield the highest conversion rate (“a measurable and desired action”). This may help with creating and comparing different challenge-response pairs. Furthermore, A/B testing may enable the device or system to indirectly learn about users themselves, including demographics such as education, age, and gender, habituation and relative performance, population segmentation, and/or the like. Using such testing, the conversion rate such as a return for desired responses including time spent and resources used may be increased.

According to an example, the items on the other transaction lists may aggregate and compete to make up or hold one or more top places on the recommendation list of challenge-response pairs (e.g., with top places reserved for preferred recommendation that make-up challenges aiming at lowering and possibly resolving the uncertainty between legitimate and imposter users). In an example, a top place recommendation may be a suitable bet or challenge (e.g., a best bet or challenge) to disambiguate between legitimate user and imposter and may be similar to a recommendation to hook one into buying something (e.g., a best recommendation). A mismatch between the expected response to a covert challenge, prompt, and/or trigger and an actual engagement or interaction on the device may indicate or raise a possibility of an intruder. The competition to make-up the recommendation list may be provided or driven by multi-armed bandit adaptation (MABA) type of strategies as described herein. This may be similar to what a gambler contends with when facing slot machines and having to decide which machines to play and in which order. For example, a challenge-response (e.g., similar to a slot machine) may be played time after time, with an objective to maximize “rewards” earned or alternatively catch a “thief”, i.e., the intruder, unauthorized user, or imposter. To maximize the “rewards” may include minimizing the loss that may be incurred when failing to detect impersonation (e.g., spoofing) or false alerts leading to locks-out; and/or the delay it may take to lock out the imposter when impersonation may actually be under way. The composition and ranking of the list such as the challenge-response list may include a “cold start” and then may proceed with exploration and exploitation to figure out what works best toward detecting imposters. As an example, exploration could involve random selection, for example, using the uniform distribution that may be followed by exploitation where a “best” challenge-response so far may be enabled. Context-based learning, forgetting, and information decay may be intertwined with exploration and exploitation using both A/B or multi split testing and multi-arm bandit adaptation to further enhance the method 500.

Another detection scheme whose returns may be fed to meta-recognition, for example, in the method 100 for adjudication may be SOM-LVQ-DTW (e.g., 415 in the method 400) that may be involved with temporal sequences and their corresponding appearance and behaviors. In such an example, situational dynamics including its time evolution may be captured as spatial-temporal trajectories in some physical space and/or its coordinates that may span context, domain, and time may be captured. Such dynamics may capture higher-order statistics and substitute for less powerful bag of words, descriptor, or indicator representations.

As shown in FIG. 5, to perform collaborative filtering and/or provide challenges, prompts, and/or triggers, at 505, A/B or multi split testing may be performed as described herein Further, in an example, at 510, multi-arm bandit adaptation (MABA) may be performed as described herein. SOM-LVQ-DTW (e.g., as described and used in the method 400) may be used and/or performed, at 515 (e.g., SOM-LVQ-DTW similar to or of 415 of the method 400 may be performed). At 520, challenges, prompts, and/or triggers may be generated and/or actuated and responses thereto may be observed, recorded, and/or the like. At 525, statistics for A/B or multi split testing, MABA, and SOM-LVQ-DTW may be updated. For example, the relative fitness of A/B or multi-split testing and MABA challenges and/or strategies may be updated. In an example, SOM prototypes and/or Voronoi diagrams may be updated as well. At 530, the responses may be evaluated and a determination may be made as to whether to perform A/B or multi split testing at 505, multi-arm bandit adaptation (MABA) at 510, SOM-LVQ-DWT at 515, and/or the method 500 may be exited. According to an example, the method 500 may be looped until a user may be determined or deemed to be an unauthorized user or imposter, the user may be determined or deemed to be authorized or legitimate, and/or the like.

As an example, methods 100-500 of FIGS. 1-5 may be invoked to determine whether a user may be a legitimate or authorized user or imposter or unauthorized user. For example, an initialization and pre-training of ensemble methods and/or user profiles of legitimate uses (e.g., to detect an imposter or unauthorized user) may be performed using the method 100. As such, the method 100 may be invoked to initialize the monitoring. During an on-going session of a user with a device, the methods 200-500 may further be invoked or executed. For example, biometric information may be accessed (e.g. at 205), and choices on how to monitor (e.g., shadow and update) a current user (e.g., behavior and profile) may be continuously made and the user monitored (e.g., at 405, 300 and 215). Scores may be generated as described herein for use of the device by the current user. The scores returned (e.g., by random boost and transduction) may be ambiguous (at 110) but not high enough to lock out the user (e.g., at 130). As such, in an example, a challenge—response may be initiated (e.g. at 120) to gain further information (e.g., at 505-510) on the user. As such, according to an example, the ambiguity (e.g., the biometrics may not be suitable to identify the current user and/or the current interactions or events executed by the current user may be insufficient to identify him or her) may be large or big enough to warrant looking into more detail at a user's behavior (e.g., sequence of behaviors) (e.g., at 515). Another attempt to determine proper or improper use based on the response received may be performed (e.g., at 125), for example, using the additional information received (e.g., the information from the method 500 and/or the other methods) and the decision may be made on whether to lock to the user or not (e.g., at 130).

The systems and/or methods described herein may provide an application for devices to use all encompassing (e.g., appearance, behavior, intent/cognitive state) biometric re-authentication for security and privacy purposes. A number of discriminative methods and closed-loop control may be provided, advanced, and/or used as described herein to maintain proper re-authentication, for example, with minimal delay for intrusion detection and lock out and/or subliminal interference to the user. As described herein, meta-recognition along with ensemble methods that may be used for flow of control, user re-authentication (e.g., that may be by random boost and/or transduction, respectively), user profile adaptation, and/or to provide covert challenges using, for example, a hybrid recommender system that may implement or use both contents-based and collaborative filtering.

The active authentication scheme and/or methods described herein may further be expanded using mutual challenge-response re-authentication, with both the device and user authenticating and re-authenticating each other. With ever increased coverage for devices, there may be a desire for the user to authenticate and re-authenticate the device, a server, cloud services, and engagements during both active and non-active conditions. This may be useful, for example, if or when an authorized or legitimate user of the device may suspect that the device may have been hacked and/or compromised (e.g., and/or may be engaged in nefarious activities). Excessive power consumption may be a characteristic of the device that may indicate that an imposter or unauthorized user may be in control in an example.

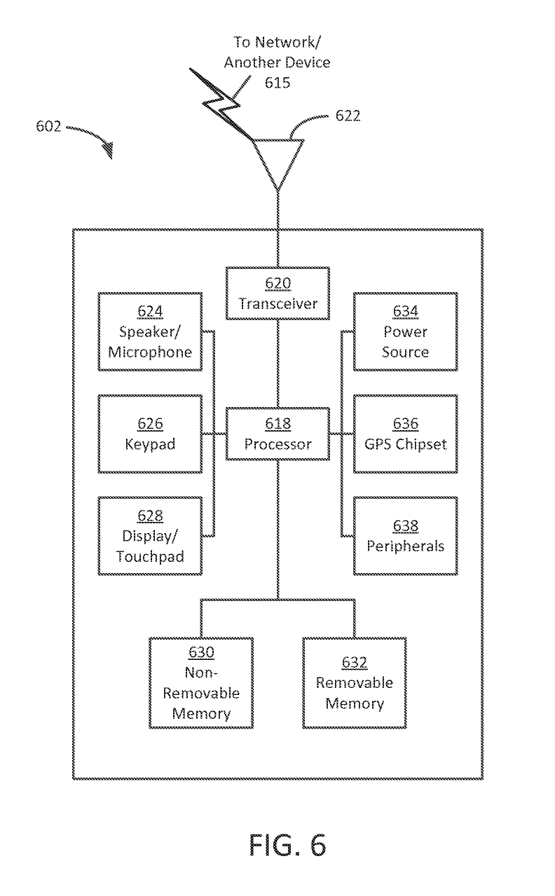

FIG. 6 depicts a system diagram of an example device such as a WTRU 602 that may be used by a device to actively authenticate a user (e.g., to detect imposters). The WTRU 602 (e.g., or device) may include the methods 100-500 of FIGS. 1-5 described herein or functionality thereof and may execute such functionality (e.g., via a processor or other device thereof according to an example). As shown in FIG. 6, the WTRU 602 may include a processor 618, a transceiver 620, a transmit/receive element 622, a speaker/microphone 624, a keypad 626, a display/touchpad 628, non-removable memory 630, removable memory 632, a power source 634, a global positioning system (GPS) chipset 636, and other peripherals 638. It may be appreciated that the WTRU 602 may include any sub-combination of the foregoing elements while remaining consistent with an embodiment. Also, embodiments contemplate that other devices and/or servers or systems described herein, may include some or all of the elements depicted in FIG. 6 and described herein.

The processor 618 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 618 may perform signal coding, data processing, power control, input/output processing, and/or any other functionality that may enable the WTRU 602 to operate in a wireless environment. The processor 618 may be coupled to the transceiver 620, which may be coupled to the transmit/receive element 622. While FIG. 6 depicts the processor 618 and the transceiver 620 as separate components, it may be appreciated that the processor 618 and the transceiver 620 may be integrated together in an electronic package or chip.

The transmit/receive element 622 may be configured to transmit signals to, or receive signals from, another device (e.g., the user's device and/or a network component such as a base station, access point, or other component in a wireless network) over an air interface 615. For example, in one embodiment, the transmit/receive element 622 may be an antenna configured to transmit and/or receive RF signals. In another or additional embodiment, the transmit/receive element 622 may be an emitter/detector configured to transmit and/or receive IR, UV, or visible light signals, for example. In yet another or additional embodiment, the transmit/receive element 622 may be configured to transmit and receive both RF and light signals. It may be appreciated that the transmit/receive element 622 may be configured to transmit and/or receive any combination of wireless signals (e.g., Bluetooth, WiFi, and/or the like).

In addition, although the transmit/receive element 622 is depicted in FIG. 6 as a single element, the WTRU 602 may include any number of transmit/receive elements 622. More specifically, the WTRU 602 may employ MIMO technology. Thus, in one embodiment, the WTRU 602 may include two or more transmit/receive elements 622 (e.g., multiple antennas) for transmitting and receiving wireless signals over the air interface 615.

The transceiver 620 may be configured to modulate the signals that are to be transmitted by the transmit/receive element 622 and to demodulate the signals that are received by the transmit/receive element 622. As noted above, the WTRU 102 may have multi-mode capabilities. Thus, the transceiver 620 may include multiple transceivers for enabling the WTRU 602 to communicate via multiple RATs, such as UTRA and IEEE 802.11, for example.

The processor 618 of the WTRU 602 may be coupled to, and may receive user input data from, the speaker/microphone 624, the keypad 626, and/or the display/touchpad 628 (e.g., a liquid crystal display (LCD) display unit or organic light-emitting diode (OLED) display unit). The processor 618 may also output user data to the speaker/microphone 624, the keypad 626, and/or the display/touchpad 628. In addition, the processor 618 may access information from, and store data in, any type of suitable memory, such as the non-removable memory 630 and/or the removable memory 632. The non-removable memory 630 may include random-access memory (RAM), read-only memory (ROM), a hard disk, or any other type of memory storage device. The removable memory 632 may include a subscriber identity module (SIM) card, a memory stick, a secure digital (SD) memory card, and the like. In other embodiments, the processor 618 may access information from, and store data in, memory that is not physically located on the WTRU 602, such as on a server or a home computer (not shown). The removable memory 630 and/or non-removable memory 632 may store a user profile or other information associated therewith that may be used as described herein.

The processor 618 may receive power from the power source 634, and may be configured to distribute and/or control the power to the other components in the WTRU 602. The power source 634 may be any suitable device for powering the WTRU 602. For example, the power source 634 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 618 may also be coupled to the GPS chipset 636, which may be configured to provide location information (e.g., longitude and latitude) regarding the current location of the WTRU 602. In addition to, or in lieu of, the information from the GPS chipset 636, the WTRU 102 may receive location information over the air interface 615 from another device or network component and/or determine its location based on the timing of the signals being received from two or more nearby network components. It will be appreciated that the WTRU 602 may acquire location information by way of any suitable location-determination method while remaining consistent with an embodiment.

The processor 618 may further be coupled to other peripherals 638, which may include one or more software and/or hardware modules that provide additional features, functionality and/or wired or wireless connectivity. For example, the peripherals 638 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

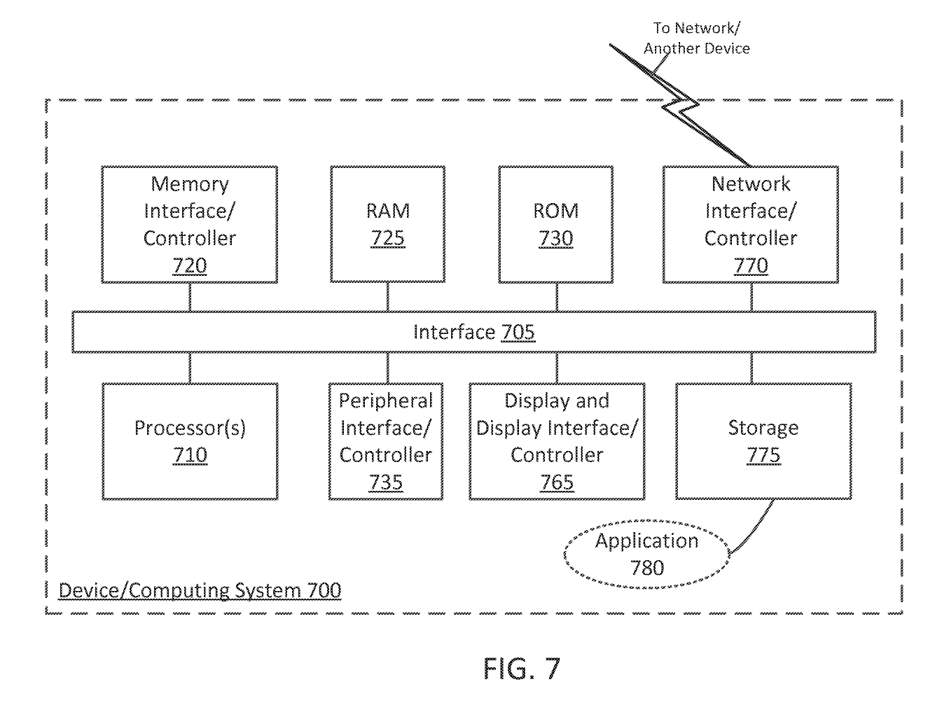

FIG. 7 depicts a block diagram of an example device or computing system 600 that may be used to implement the systems and methods described herein. For example, the device or computing system 700 may be used as the server and/or devices described herein. The device or computing system 700 may be capable of executing a variety of computing applications 780 (e.g., that may include the methods 100-500 of FIGS. 1-5 described herein or functionality thereof). The computing applications 780 may be stored in a storage component 775 (and/or RAM or ROM described herein). The computing application 780 may include a computing application, a computing applet, a computing program and other instruction set operative on the computing system 700 to perform at least one function, operation, and/or procedure as described herein. According to an example, the computing applications may include the methods and/or applications described herein. The device or computing system 700 may be controlled primarily by computer readable instructions that may be in the form of software. The computer readable instructions may include instructions for the computing system 700 for storing and accessing the computer readable instructions themselves. Such software may be executed within a processor 610 such as a central processing unit (CPU) and/or other processors such as a co-processor to cause the device or computing system 700 to perform the processes or functions associated therewith. In many known computer servers, workstations, personal computers, or the like, the processor 710 may be implemented by micro-electronic chips CPUs called microprocessors.

In operation, the processor 710 may fetch, decode, and/or execute instructions and may transfer information to and from other resources via an interface 705 such as a main data-transfer path or a system bus. Such an interface or system bus may connect the components in the device or computing system 700 and may define the medium for data exchange. The device or computing system 700 may further include memory devices coupled to the interface 705. According to an example embodiment, the memory devices may include a random access memory (RAM) 725 and read only memory (ROM) 730. The RAM 725 and ROM 730 may include circuitry that allows information to be stored and retrieved. In one embodiment, the ROM 730 may include stored data that cannot be modified. Additionally, data stored in the RAM 725 typically may be read or changed by the processor 710 or other hardware devices. Access to the RAM 725 and/or ROM 730 may be controlled by a memory controller 720. The memory controller 720 may provide an address translation function that translates virtual addresses into physical addresses as instructions are executed.

In addition, the device or computing system 700 may include a peripherals controller 635 that may be responsible for communicating instructions from the processor 710 to peripherals such as a printer, a keypad or keyboard, a mouse, and a storage component. The device or computing system 700 may further include a display and display controller 765 (e.g., the display may be controlled by a display controller). The display/display controller 765 may be used to display visual output generated by the device or computing system 700. Such visual output may include text, graphics, animated graphics, video, or the like. The display controller associated with the display (e.g., shown in combination as 765 but may be separate components) may include electronic components that generate a video signal that may be sent to the display. Further, the computing system 700 may include a network interface or controller 770 (e.g., a network adapter) that may be used to connect the computing system 700 to an external communication network and/or other devices (not shown).

Although the terms device, UE, or WTRU may be used herein, it may and should be understood that the use of such terms may be used interchangeably and, as such, may not be distinguishable.

According to examples, authentication, identification, and/or recognition may be used interchangeable throughout. Further, algorithm, method, and model may be used interchangeable throughout.

Further, although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for performing active authentication on a device to detect an imposter,
the method comprising:
comparing a profile generated for a session of a user currently using the device with user profiles associated with a legitimate user and a generic profile associated in a general population;
computing, based on the comparison, scores for the legitimate user profile and the generic profile based on their similarity to the profile for the session of the user currently using the device;
determining, based on the scores, whether to continue to enable access to the device, whether to invoke collaborative filtering or challenge-responses for additional information, or whether to lock the device; and
providing access to the device when, based on the determination, a highest score or result of the scores or results is associated with one of the user profiles for the legitimate user and exceeds a threshold of scores.

2. The method of claim 1, further comprising: updating one or more of the user profiles for the legitimate user with features or characteristics in the profile for the session of the user currently using the device when, based on the determination, the highest score of the scores and results is associated with one of the user profiles for the legitimate user and exceeds a threshold of scores.

3. The method of claim 1, wherein the threshold of scores comprises a first score and a second score.

4. The method of claim 3, wherein determining, based on the scores, whether to continue to enable access to the device, whether to invoke collaborative filtering or challenge-responses for additional information, or whether to lock the device comprises: determining whether the highest score or result is associated with one of the user profiles for the legitimate user; comparing the highest score with the first score and the second score of the threshold of scores; and determining whether the highest score or result exceeds at least one of the first score or second score of the threshold of scores.

5. The method of claim 4, wherein access is provided to the device when, based on the determination, the highest score or result of the scores or results is associated with one of the user profiles for the legitimate user and exceeds the first score of the threshold of score.

6. The method of claim 4, wherein collaborative filtering or challenge-responses are invoked for additional information when, based on the determination, the highest score or result of the scores or results is associated with one of the user profiles for the legitimate user, exceeds the second score of the threshold of scores, and is less than the first score of the threshold of scores.

7. The method of claim 4, wherein the device is locked when, based on the determination, the highest score or result of the scores or results is associated with the generic profile or is less than the first score and second score of the threshold of scores.

8. A computing device, comprising:
a processor that is configured to:
compare a profile generated for a session of a user currently using the device with user profiles associated with a legitimate user and a generic profile associated in a general population;
compute, based on the comparison, scores for the legitimate user profile and the generic profile based on their similarity to the profile for the session of the user currently using the device;
determine, based on the scores, whether to continue to enable access to the device, whether to invoke collaborative filtering or challenge-responses for additional information, or whether to lock the device; and
provide access to the device when, based on the determination, a highest score or result of the scores or results is associated with one of the user profiles for the legitimate user and exceeds a threshold of scores.

9. The device of claim 8, wherein the processor is further configured in part to: update one or more of the user profiles for the legitimate user with features or characteristics in the profile for the session of the user currently using the device when, based on the determination, the highest score of the scores and results is associated with one of the user profiles for the legitimate user and exceeds a threshold of scores.

10. The device of claim 8, wherein the threshold of scores comprises a first score and a second score.

11. The device of claim 10, wherein the processor is further configured to determine, based on the scores, whether to continue to enable access to the device, whether to invoke collaborative filtering or challenge-responses for additional information, or whether to lock the device by: determining whether the highest score or result is associated with one of the user profiles for the legitimate user; comparing the highest score with the first score and the second score of the threshold of scores; and determining whether the highest score or result exceeds at least one of the first score or second score of the threshold of scores.

12. The device of claim 11, wherein the processor is further configured to provide access to the device when, based on the determination, the highest score or result of the scores or results is associated with one of the user profiles for the legitimate user and exceeds the first score of the threshold of score.

13. The device of claim 11, wherein the processor is further configured to invoke collaborative filtering or challenge-responses for additional information when, based on the determination, the highest score or result of the scores or results is associated with one of the user profiles for the legitimate user, exceeds the second score of the threshold of scores, and is less than the first score of the threshold of scores.

14. The device of claim 11, wherein the processor is further configured to lock the device when, based on the determination, the highest score or result of the scores or results is associated with the generic profile or is less than the first score and second score of the threshold of scores.
